(19) United States
(12) Patent Application Publication
(10) Pub. No.: US 2026/0188660 A1
(43) Pub. Date: Jul. 2, 2026

(54) NEGATIVE ELECTRODE, RECHARGEABLE LITHIUM BATTERY INCLUDING THE SAME, AND METHOD FOR MANUFACTURING THE SAME

(71) Applicant: SAMSUNG SDI CO., LTD., Yongin-si (KR)

(72) Inventor: Banseok LEE, Yongin-si (KR)

(73) Assignee: SAMSUNG SDI CO., LTD., Yongin-si (KR)

(21) Appl. No.: 19/434,094

(22) Filed: Dec. 29, 2025

(30) Foreign Application Priority Data
Dec. 30, 2024 (KR) 10-2024-0200812

(51) Int. Cl. H01M 4/36; H01M 4/02; H01M 4/04; H01M 4/133; H01M 4/134; H01M 4/1393; H01M 4/1395; H01M 4/38; H01M 4/587

(52) U.S. Cl. CPC H01M 4/366; H01M 4/0404; H01M 4/0428; H01M 4/043; H01M 4/133; H01M 4/134; H01M 4/1393; H01M 4/1395; H01M 4/364; H01M 4/386; H01M 4/587; H01M 2004/021; H01M 2004/027

(57) ABSTRACT

The present disclosure relates to a negative electrode for a rechargeable lithium battery, a rechargeable lithium battery including the negative electrode, and a method for manufacturing the negative electrode. The negative electrode includes a negative electrode current collector, and a negative electrode active material layer on the negative electrode current collector. The negative electrode active material layer includes a first negative electrode active material layer on the negative electrode current collector, and a second negative electrode active material layer on the first negative electrode active material layer. The first negative electrode active material layer includes a first silicon-carbon composite and a first graphite. The second negative electrode active material layer includes a second silicon-carbon composite and a second graphite.

### CROSS-REFERENCE TO RELATED APPLICATION

This U.S. nonprovisional application claims priority under 35 U.S.C § 119 to Korean Patent Application No. 10-2024-0200812 filed on Dec. 30, 2024 in the Korean Intellectual Property Office, the disclosure of which is hereby incorporated by reference in its entirety.

### BACKGROUND

The present disclosure relates to a negative electrode for a rechargeable lithium battery, a rechargeable lithium battery including the negative electrode, and a method for manufacturing the negative electrode, and more particularly, to a negative electrode having a double layer structure and a rechargeable lithium battery including the negative electrode.

With increasing presence of battery-powered electronic devices such as, e.g., mobile phones, notebook computers, electric vehicles, and the like, the demand for rechargeable batteries with high energy density and large capacity has increased significantly. In response, enhancing the performance of rechargeable lithium batteries may be advantageous.

A rechargeable lithium battery generally includes a positive electrode, a negative electrode, and an electrolyte. Both the positive and negative electrodes contain active materials capable of lithium-ion intercalation and deintercalation. Electrical energy is generated through oxidation and reduction reactions as lithium ions move between the electrodes during charging and discharging.

### SUMMARY

An example embodiment of the present disclosure includes a stable negative electrode for a rechargeable lithium battery having low resistance and an improved cycle-life characteristics.

An example embodiment of the present disclosure includes a stable rechargeable lithium battery having low resistance and improved cycle-life characteristics.

According to an example embodiment of the present disclosure, a negative electrode for a rechargeable lithium battery may include a negative electrode current collector and a negative electrode active material layer on the negative electrode current collector. The negative electrode active material layer may include a first negative electrode active material on the negative electrode current collector, and a second negative electrode active material layers on the first negative electrode active materials layer, the first negative electrode active material layers may include a first silicon-carbon composite and a first graphite, and the first silicon-carbon composite may include a first carbon and first silicon particles dispersed in the first carbon. The second negative electrode active material layer may include a second silicon-carbon composite and second graphite, the second silicon-carbon composite may include second carbon and second silicon particles dispersed in the second carbon, and an average particle diameter of the second silicon particles may be larger than an average particle diameters of the first silicon particles.

According to another concept of the present disclosure, a method for manufacturing a negative electrode for a rechargeable lithium battery may include forming a first silicon-carbon composite, and mixing the first silicon-carbon composite and first graphite to form a first negative electrode active material slurry, and forming a second silicon-carbon composite, and mixing the second silicon-carbon composite with second graphite to form second negative electrode active material slurries, and coating the first negative electrode active materials slurry on a negative electrode current collector to form a first positive electrode active material layer. The method further includes coating a second negative electrode active material slurry onto the first negative electrode active material layer to form a second negative electrode activity layer, wherein forming the first silicon-carbon composite includes performing a vapor deposition process to form first silicon particles in a first carbon, and wherein forming the second silicon-carbon composite may include performing a milling process to form second silicon particles; and coating the second silicon particles with a second carbon.

According to another concept of the present disclosure, a rechargeable lithium battery may include a negative electrode according to the present disclosure, a positive electrode, and an electrolyte between the negative electrode and the positive electrode.

### BRIEF DESCRIPTION OF DRAWINGS

FIG. 1 is a simplified conceptual diagram illustrating a rechargeable lithium battery according to example embodiments of the present disclosure.

FIG. 2 to FIG. 5 are diagrams illustrating a rechargeable lithium battery according to example embodiments of the present disclosure.

FIG. 6 is a cross-sectional view illustrating a rechargeable lithium battery according to example embodiments of the present disclosure.

FIG. 7A and FIG. 7B are each enlarged cross-sectional views of the “M” and “N” regions of FIG. 6.

FIG. 8A and FIG. 8B are each enlarged cross-sectional views of the “SC1” region of FIG. 7A and the “SC2” region of FIG. 7B.

FIG. 9 and FIG. 10 are SEM images of silicon-carbon composites prepared according to Embodiment 1 and converted to grayscale.

FIG. 11 is a flowchart illustrating a method of manufacturing a negative electrode, according to an example embodiment.

### DETAILED DESCRIPTION OF EMBODIMENTS

To fully understand the configuration and effects of the present disclosure, some example embodiments are described with reference to the accompanying drawings. However, the present disclosure is not limited to the following example embodiments and may be implemented in various forms. The example embodiments are provided solely to illustrate the present disclosure and to enable those skilled in the art to fully understand its scope.

In this description, when an element is described as being “on” another element, the element may be “directly on” the other element, or one or more intervening elements may be present therebetween. In the drawings, certain thicknesses may be exaggerated to better illustrate technical details. Throughout the specification, like reference numerals indicate like elements.

Unless otherwise explicitly stated in this description, singular forms may also include plural forms. In addition, unless explicitly stated otherwise, the phrase “A or B” may indicate “A but not B,” “B but not A,” and “A and B.” The terms “comprises/includes” and “comprising/including” do not exclude the presence or addition of one or more other components.

In this description, the phrase “combination thereof” may refer to a mixture, a stack, a composite, a copolymer, an alloy, a blend, or a reaction product.

Unless otherwise specifically defined, the term “particle diameter” refers to an average particle diameter. The particle diameter may represent the median particle size (D50), which corresponds to the diameter of particles at 50 vol % in a cumulative particle size distribution. The average particle diameter (D50) can be measured using widely known methods, such as, e.g., a particle size analyzer, transmission electron microscope (TEM) imaging, or scanning electron microscope (SEM) imaging. Alternatively, dynamic light scattering may be used, where particle counts within size ranges are analyzed to calculate the average particle diameter (D50). Additionally, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution.

When the terms “about” or “substantially” are used in this specification in connection with a numerical value, it is intended that the associated numerical value include a tolerance of =10% around the stated numerical value. When ranges are specified, the range includes all values therebetween such as increments of 0.1%.

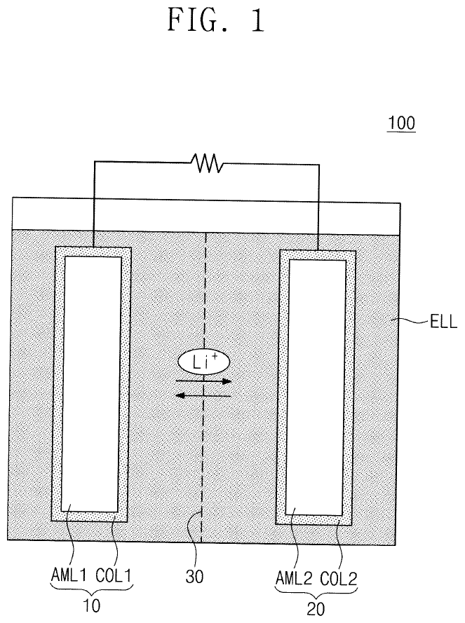

FIG. 1 is a simplified conceptual diagram illustrating a rechargeable lithium battery according to example embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material, and may further include a binder and/or a conductive material.

For example, the positive electrode 10 may further include an additive that can constitute a sacrificial positive electrode.

An amount of the positive electrode active material may be in a range of about 90 wt % to about 99.5 wt % relative to 100 wt % of the positive electrode active material layer AML1. An amount of each of the binder and the conductive material may be in a range of about 0.5 wt % to about 5 wt % relative to 100 wt % of the positive electrode active material layer AML1.

The binder may improve attachment of positive electrode active material particles to each other, and improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present invention is not limited thereto.

The conductive material may provide an electrode with conductivity, and any suitable conductive material that does not cause an undesirable chemical change in a battery may be used as the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be used as the current collector COL1, but the present invention is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include a lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b} O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)} Fe₂ (PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high-nickel-based positive electrode active material having a nickel amount that is equal to or greater than about 80 mol %, equal to or greater than about 85 mol %, equal to or greater than about 90 mol %, equal to or greater than about 91 mol %, or equal to or greater than about 94 mol % and equal to or less than about 99 mol %, relative to 100 mol % of metal devoid of lithium in the lithium transition metal composite oxide. The high-nickel-based positive electrode active material may exhibit high capacity, and thus may be applicable to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material, and may further include a binder and/or a conductive material.

For example, the negative electrode active material layer AML2 may include a negative electrode active material in a range of about 90 wt % to about 99 wt %, a binder in a range of about 0.5 wt % to about 5 wt %, and a conductive material in a range of about 0 wt % to about 5 wt %.

The binder may improve attachment of negative electrode active material particles to each other, and to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material that does not cause an undesirable chemical change in a battery may be used as the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x≤2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be used in combination with a carbon-based negative electrode active material.

### Separator 30

Based on the type of rechargeable lithium battery, the separator 30 may be present between positive electrode 10 and the negative electrode 20. The separator 30 may include at least one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present invention is not limited thereto.

The organic material and the inorganic material may be mixed in one coating layer, or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone, or in a mixture of two or more solvents.

In addition, when a carbonate-based solvent is used, a cyclic carbonate and a chain carbonate may be mixed, and the cyclic carbonate and the chain carbonate may be mixed in a volume ratio in a range of about 1:1 to about 1:9.

The lithium salt may be or include a material that dissolves in the non-aqueous organic solvent to constitute a supply source of lithium ions in a battery and to enable a basic operation of a rechargeable lithium battery and promote the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (where x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB)

### Rechargeable Lithium Battery

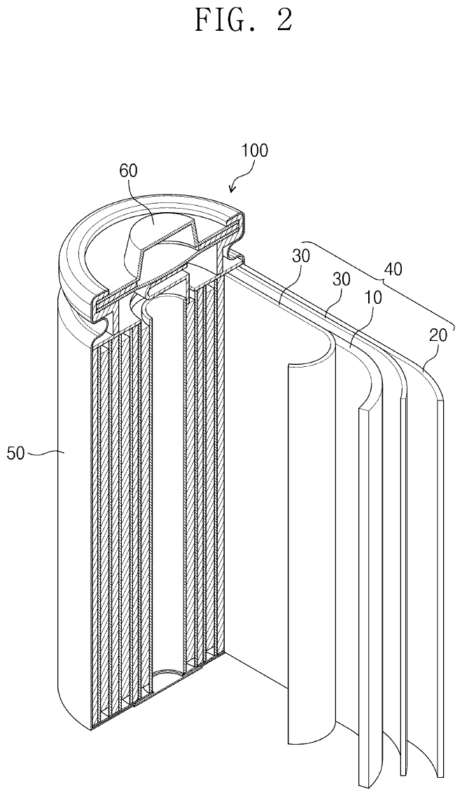

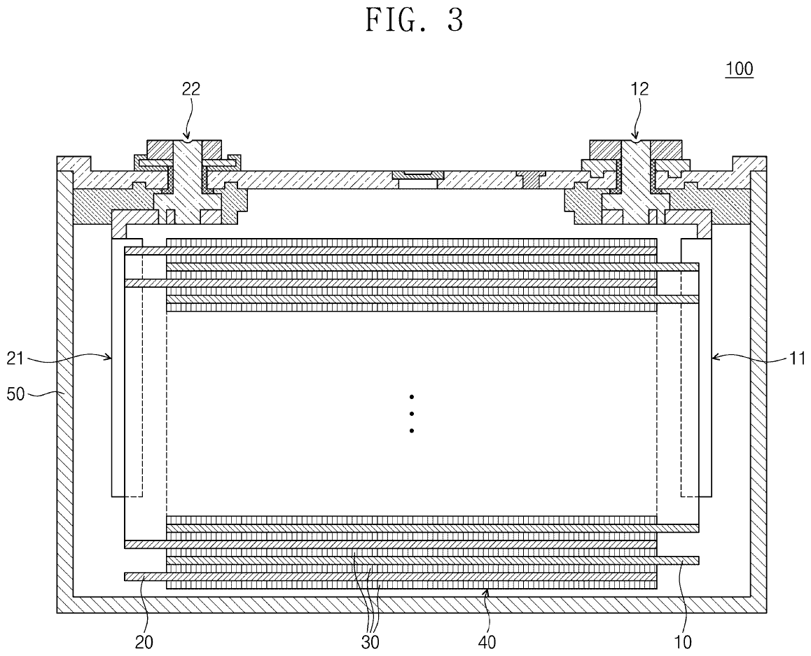

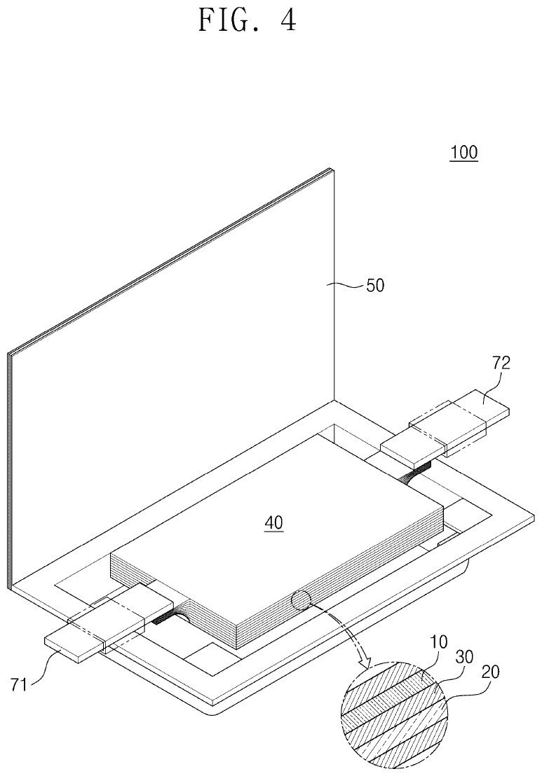

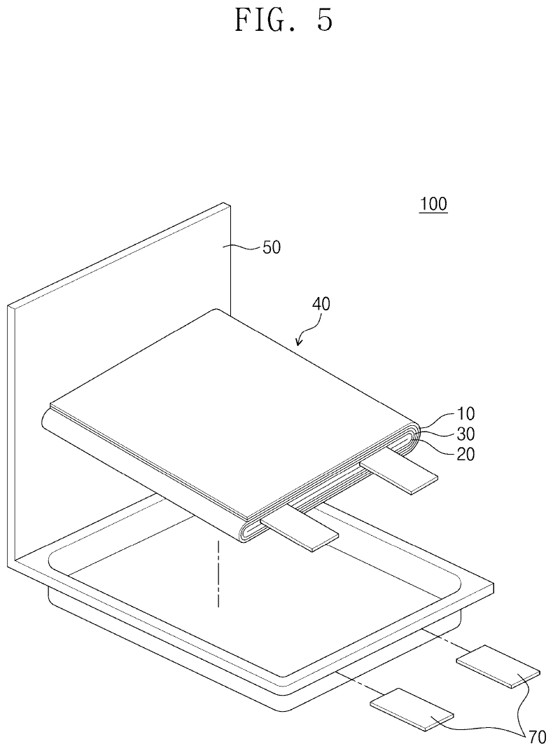

Based on shape of a rechargeable lithium battery, the rechargeable lithium battery may be classified into cylindrical, prismatic, pouch, and coin types. In FIG. 2 to FIG. 5 illustrating simplified diagrams showing a rechargeable lithium battery according to an example embodiment, FIG. 2 shows a cylindrical battery, FIG. 3 shows a prismatic battery, and FIG. 4 and FIG. 5 show pouch-type batteries. Referring to FIG. 2 to FIG. 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 4 and FIG. 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 forming an electrical path for externally inducing a current generated in the electrode assembly 40.

The rechargeable lithium battery according to an example embodiment may be applicable to, e.g., automobiles, mobile phones, and/or various types of electric devices, as non-limiting examples.

The following description focuses on a rechargeable lithium battery according to example embodiments of the present disclosure.

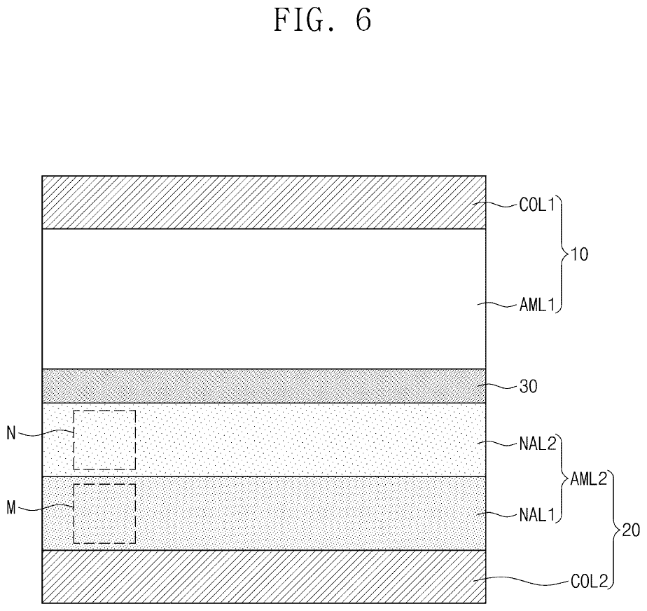

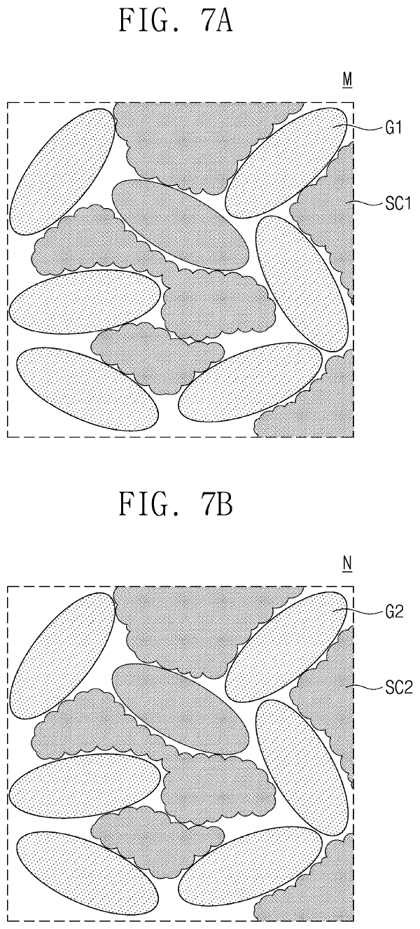

FIG. 6 is a cross-sectional view illustrating a rechargeable lithium battery according to example embodiments of the present disclosure. FIG. 7A and FIG. 7B are each enlarged cross-sectional views of the M and N regions of FIG. 6.

Referring to FIG. 6, FIG. 7A and FIG. 7B, as described above with reference to FIG. 1, the rechargeable lithium battery according to the present disclosure may include a positive electrode 10, a negative electrode 20, and a separator 30 between the positive electrode 10 and the negative electrode 20. Although not explicitly shown in FIG. 6, the rechargeable lithium battery according to examples of the present disclosure may further include an electrolyte ELL. The separator 30 may be impregnated with the electrolyte ELL.

The positive electrode 10 may include a positive electrode current collector COL1 and a positive electrode active material layer AML1 on the positive electrode current collector COL1. The negative electrode 20 may include a negative electrode current collector COL2 and a negative electrode active material layer AML2 on the negative electrode current collector COL2. The separator 30 may be interposed between the positive electrode active material layer AML1 and the negative electrode active material layer AML2.

The negative electrode active material layer AML2 according to example embodiments of the present disclosure may have a double-layer structure. For example, the negative electrode active material layer AML2 may include a first negative electrode active material layer NAL1 and a second negative electrode active material layer NAL2 that are sequentially stacked. The first negative electrode active material layer NAL1 may be directly provided on the negative electrode current collector COL2. The second negative electrode active material layer NAL2 may be interposed between the first negative electrode active material layer NAL1 and the separator 30.

The first and second negative electrode active material layers NAL1 and NAL2 may include different negative electrode active materials. In other words, the first and second negative electrode active material layers NAL1 and NAL2 may have different compositions. Each of, or at least one of, the first and second negative electrode active material layers NAL1 and NAL2 may include a carbon-based negative electrode active material. For example, a carbon-based negative electrode active material may include, crystalline carbon, amorphous carbon, or a combination thereof. Detailed description thereof may be the same as described in the negative electrode active material above.

The first negative electrode active material layer NAL1 may include a first silicon-carbon composite SC1 and a first graphite G1, as illustrated in FIG. 7A. The second negative electrode active material layer NAL2 may include a second silicon-carbon composite SC2 and a second graphite G2, as illustrated in FIG. 7B. Each of, or at least one of, the first graphite G1 and the second graphite G2 may be or include natural graphite, artificial graphite, or a mixture thereof.

The first negative electrode active material layer NAL1 may further include a binder. An amount of the binder of the first negative electrode active material layer NAL1 may be in a range of about 1 wt % to about 10 wt %. The second negative electrode active material layer NAL2 may further include a binder. An amount of the binder of the second negative electrode active material layer NAL2 may be in a range of about 1 wt % to about 10 wt %. Meanwhile, a high amount of the binder in the active material layer may present a challenge of reducing the migration rate of lithium ions.

In an example embodiment of the present disclosure, an amount of the first silicon-carbon composite SC1 in the first negative electrode active material layer NAL1 may be in a range of about 10 parts by weight to about 80 parts by weight, about 30 parts by weight to about 60 parts by weight, or about 40 parts by weight to about 55 parts by weight relative to 100 parts by weight of the first negative electrode active material layer NAL1. An amount of the first graphite G1 in the first negative electrode active material layer NAL1 may be in a range of about 20 parts by weight to about 90 parts by weight, about 40 parts by weight to about 70 parts by weight, or about 45 parts by weight to about 60 parts by weight relative to 100 parts by weight of the first negative electrode active material layers NAL1.

A proportion of the natural graphite in the first graphite G1 may be in a range of about 0 wt % to about 100 wt %, about 50 wt % to about 100 wt %, or about 80 wt % to about 100 wt % relative to a total weight of the first graphite G1. In the first graphite G1, a remainder excluding the natural graphite may be or include the artificial graphite. A proportion of the natural graphite in the first graphite G1 may be greater than a proportion of the artificial graphite.

In an example embodiment of the present disclosure, an amount of the second silicon-carbon composite SC2 in the second negative electrode active material layer NAL2 may be in a range of about 10 parts by weight to about 80 parts by weight, about 30 parts by weight to about 60 parts by weight, or about 40 parts by weight to about 55 parts by weight relative to 100 parts by weight of the second negative electrode active material layer NAL2. An amount of the second graphite G2 in the second negative electrode active material layer NAL2 may be in a range of about 20 parts by weight to about 90 parts by weight, about 40 parts by weight to about 70 parts by weight, or about 45 parts by weight to about 60 parts by weight relative to 100 parts by weight of the second negative electrode active material layer NAL2.

A proportion of the natural graphite in the second graphite G2 may be in a range of about 0 wt % to about 100 wt %, about 50 wt % to about 100 wt %, or about 80 wt % to about 100 wt % relative to a total weight of the second graphite G2. In the second graphite G2, a remainder excluding the natural graphite may be or include the artificial graphite. In the second negative electrode active material layer NAL2, a proportion of the artificial graphite in the second graphite G2 may be greater than a proportion of the natural graphite in the second graphite G2.

The first silicon-carbon composite SC1 may include the first graphite G1, so that the structure of the first silicon-carbon composite SC1 may be maintained, and the negative electrode may have better electrical conductivity. The second silicon-carbon composite SC2 may include the second graphite G2, so that the structure of the second silicon-carbon composite SC2 may be maintained, and the negative electrode may have better electrical conductivity.

### Silicon-Carbon Composite SC1 and SC2

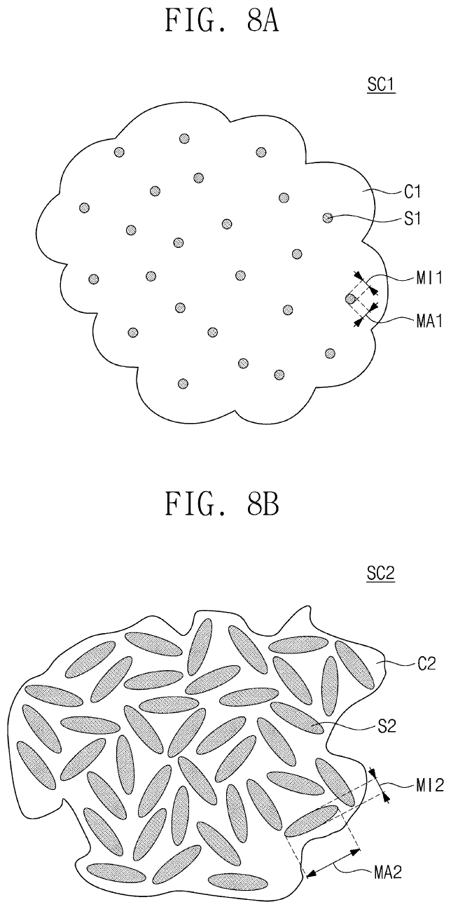

FIG. 8A is an enlarged cross-sectional view of a first silicon-carbon composite SC1 of FIG. 7A. FIG. 8B is an enlarged cross-sectional view of a second silicon-carbon composite SC2 of FIG. 7B.

Referring to FIG. 8A, the first silicon-carbon composite SC1 may include a first carbon C1 and a plurality of first silicon particles S1 dispersed within the first carbon C1.

Referring to FIG. 8B, the second silicon-carbon composite SC2 may include a second carbon C2 and a plurality of second silicon particles S2 dispersed within the second carbon C2.

An average particle diameter of each of the first silicon-carbon composite SC1 and the second silicon-carbon composite SC2 may be in a range of about 5 μm to about 15 μm. For example, in this description, the average particle diameter may be measured by, e.g., a particle size analyzer. The average particle diameter may indicate a diameter of particles having a cumulative volume of 50 vol % in the particle size distribution.

As an example, a proportion of the first silicon particles S1 in the first silicon-carbon composite SC1 may be in a range of about 44 wt % to about 65 wt % relative to a total weight of the first silicon-carbon composite SC1. For example, a proportion of the first silicon particles S1 in the first silicon-carbon composite SC1 may be about 52 wt % to about 62 wt %. When an amount of the first silicon particles S1 satisfies the above-described range, the rechargeable lithium battery may have desired or improved capacity and efficiency.

As an example, a ratio of the second silicon particles S2 in the second silicon-carbon composite SC2 may be in a range of about 44 wt % to about 65 wt % relative to a total weight of the second silicon-carbon composite SC2. For example, a proportion of the second silicon particles S2 in the second silicon-carbon composite SC2 may be about 52 wt % to about 62 wt %. When an amount of the second silicon particles S2 satisfies the above-described range, the rechargeable lithium battery may have desired or improved capacity and efficiency.

Each of, or at least one of, the first silicon particles S1 and the second silicon particles S2 may include amorphous silicon, crystalline silicon, or a combination thereof. Each of the first and second silicone particles S1 and S2 may have a sphere-shape, a plate-shape, or an elliptical sphere-shape.

Each of, or at least one of, the first carbon C1 and the second carbon C2 may include crystalline carbon, amorphous carbon, or a combination thereof. For example, the crystalline carbon may include graphite such as natural graphite or artificial graphite, which has a non-shape, a plate-shape, a flake-shape, a sphere-shape or a fiber-shape. For example, the amorphous carbon may include at least one of soft carbon, hard carbon, mesophase pitch carbide, calcined coke, and the like. As an example, the first carbon C1 may include hard carbon, and the second carbon C2 may include soft carbon.

Each of, or at least one of, the first carbon C1 of the first silicon-carbon composite SC1 and the second carbon C2 of the second silicon-carbon composite SC2 may have a matrix structure. The first silicon S1 of the first silicon-carbon composite SC1 may be dispersed within the matrix structure of the first carbon C1. The second silicon S2 of the second silicon-carbon composite SC2 may be dispersed within the matrix structure of the second carbon C2.

The first silicon particles S1 may have a nanoparticle shape. An average particle diameter of the first silicon particles S1 may be in a range of about 1 nm to about 100 nm. For example, the average particle diameter of the first silicon particles S1 may be about 1 nm to about 20 nm, or about 1 nm to about 10 nm. When the average particle diameter of the first silicon particles S1 satisfies the above-described range, volume expansion of the first silicon particle S1 during charging and discharging may be reduced or suppressed, structural collapse may be reduced or prevented, and the cycle-life characteristics may be desired or improved.

The first silicon particles S1 may have a long axis and a short axis. As an example, the long axis MA1 of the first silicon particles S1 may be a width of the first silicon particles S1, and the short axis MI1 of the first silicon particles may be a thickness of the first silicon particles S1. The first silicon particles SC1 may have a sphere-shape in which a ratio of the long axis MA1 to the short axis MI1 is in a range of about 1.0 to about 1.2.

The second silicon particles S2 may have a nanoparticle shape. An average particle diameter of the second silicon particles S2 may be greater than the average particle diameter of the first silicon particles S1. The average particle diameter of the second silicon particles S2 may be in a range of about 30 nm to about 500 nm. For example, the average particle diameter of the second silicon particles S2 may be about 30 nm to about 300 nm, or about 50 nm to about 150 nm. When the average particle diameter of the second silicon particles S2 satisfies the above-described range, volume expansion of the second silicon particles S2 during charging and discharging may be reduced or suppressed, structural collapse may be reduced or prevented, and resistance characteristics may be desired or improved.

The second silicon particles S2 may have a long axis and a short axis. As an example, the long axis MA2 of the second silicon particles S2 may be a width of the second silicon particles S2, and the short axis MI2 of the second silicon particles S2 may be a thickness of the second silicon particles S2. The second silicon particles SC2 may have a flake-shape in which a ratio of the long axis MA2 to the short axis MI2 is in a range of about 2.0 to about 40.

Each of the average particle diameter of the first silicon particles S1 and second silicon particles S2 may be measured using, e.g., SEM or TEM. After the first silicon-carbon composite SC1 and the second silicon-carbon composite SC2 may be prepared in a dispersed form, metal coating may be performed to impart conductivity. The SEM or TEM images of the first and second silicon-carbon composites SC1 and SC2 may be converted to grayscale, where dark regions correspond to silicon, and bright regions correspond to carbon. Using Image J, an automatic threshold may be set based on the Otsu algorithm. The arithmetic mean of the long and short axis of the silicon particles may then be calculated. The average particle diameter may be determined by measuring an average size of about 100 or more particles in the SEM or TEM image.

The average particle diameter of the first silicon particles S1 and the second silicon particles S2 may be measured using, e.g., dynamic light scattering DLS. After the first silicon-carbon composite SC1 and the second silicon-carbon composite SC2 may be prepared in a dispersed form, changes in scattered light due to the Brownian motion of the particles may be measured by using, e.g., a dynamic light scattering (DLS) device. The measurement may be performed at a laser wavelength of 633 nm, with a scattering angle of 90° or 173°, for 60 seconds to 120 seconds. Based on the variation in scattered light over time, the hydrated particle size may be calculated using the Stokes-Einstein equation. The average particle diameter may be determined by measuring an average size of about 100 or more particles.

The negative electrode for the rechargeable lithium battery according to an example embodiment of the present disclosure may ensure both the advantage of the first silicon-carbon composite SC1 having desired or improved cycle-life characteristics, and the advantage of the second silicon-carbon composite SC2 having desired or improved resistance characteristics. For example, inside the negative electrode 20, the first silicon-carbon composite SC1, which exhibits desired or improved cycle-life characteristics, may be located, while the second silicon-carbon composite SC2, which has desired or improved resistance characteristics, may be located closer to the positive electrode 10. That is, the negative electrode 20 of the present disclosure may include a combination of the first and second silicon-carbon composites SC1 and SC2, thereby achieving high capacity and high energy density, and further improving resistance characteristics and cycle-life characteristics more.

A method for manufacturing a negative electrode for a rechargeable lithium battery according to an example embodiment of the present disclosure may include forming a first silicon-carbon composite SC1, mixing the first silicon-carbon composite SC1 and a first graphite G1 to form a first negative electrode active material slurry, forming a second silicon-carbon composite SC2, mixing the second silicon-carbon composite SC2 and a second graphite G2 to form a second negative electrode active material slurry, coating the first negative electrode active material slurry on a negative electrode current collector COL2 to form a first negative electrode active material layer NAL1, and coating the second negative electrode active material slurry on the first negative electrode active material layer NAL1 to form a second negative electrode active material layer NAL2.

Forming the first silicon-carbon composite SC1 may include performing a vapor deposition process to form first silicon particles S1 within a first carbon C1.

Forming the second silicon-carbon composite SC2 may include performing a milling process to form second silicon particles S2; and coating the second silicon particles S2 with a second carbon C2.

Forming the first silicon-carbon composite SC1 may further include forming the first carbon C1 using a porous carbon matrix.

The vapor deposition process is performed at a temperature in a range of about 400° C. to about 700° C.

The milling process is performed at a temperature in a range of about 15° C. to about 100° C.

An average particle diameter of the second silicon particles S2 is greater than an average particle diameter of the first silicon particles S1.

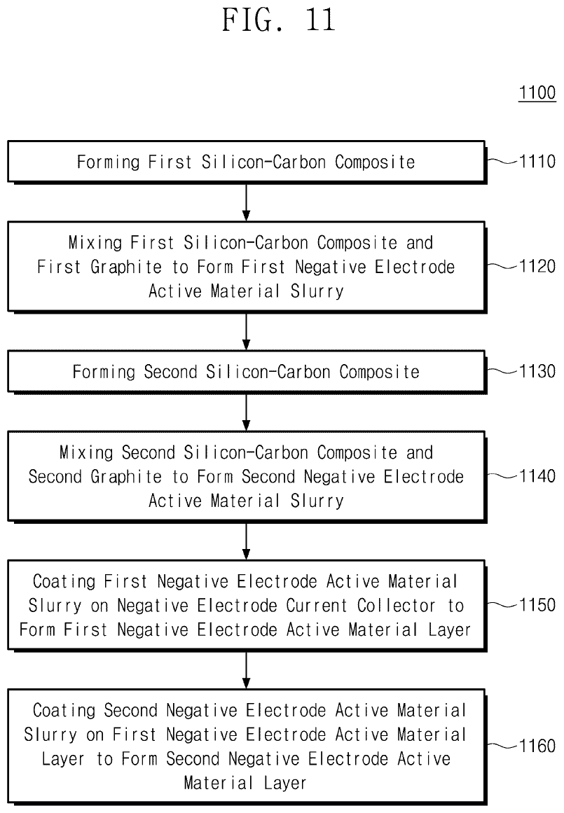

FIG. 11 is a flowchart illustrating a method of manufacturing a negative electrode, according to an example embodiment. In FIG. 11, the method 1100 includes operation 1110, which includes forming a first silicon-carbon composite. For example, forming the first silicon-carbon composite comprises performing a vapor deposition process to form first silicon particles within a first carbon. In another example, the vapor deposition process is performed at a temperature in a range of about 400° C. to about 700° C. In yet another example, forming the first silicon-carbon composite further comprises forming the first carbon using a porous carbon matrix. Operation 1120 includes mixing the first silicon-carbon composite and a first graphite to form a first negative electrode active material slurry.

Operation 1130 includes forming a second silicon-carbon composite. For example, forming the second silicon-carbon composite comprises performing a milling process to form second silicon particles, and coating the second silicon particles with a second carbon. In an example, the milling process is performed at a temperature in a range of about 15° C. to about 100° C. In another example, an average particle diameter of the second silicon particles is greater than an average particle diameter of the first silicon particles. Operation 1140 includes mixing the second silicon-carbon composite and a second graphite to form a second negative electrode active material slurry. Operation 1150 includes coating the first negative electrode active material slurry on a negative electrode current collector to form a first negative electrode active material layer. Operation 1160 includes coating the second negative electrode active material slurry on the first negative electrode active material layer to form a second negative electrode active material layer.

Examples of the present disclosure are described in more detail below. However, the following examples are merely illustrative for facilitating the understanding of the present disclosure, and should not be construed as limiting the scope of the present disclosure.

### Embodiment 1

A negative electrode plate was prepared, including a first active material layer including a first silicon-carbon composite and a first graphite, and a second active material layer including a second silicon-carbon composite and a second graphite. The negative electrode plate was manufactured by the following method.

### Preparation Example 1: Preparation of First Silicon-Carbon Composite

A mixture was prepared by mixing artificial graphite and Fe (average size (D50): 100 nm) at a weight ratio of 80:20. The mixture was heat-treated at 1500° C. under a N₂ atmosphere to prepare a heat-treated product including Fe and artificial graphite. The heat-treated product was immersed in hydrochloric acid to prepare the Fe-removed porous carbon matrix. The porous carbon matrix was soft carbon.

An amorphous silicon was supported on the prepared porous carbon matrix using chemical vapor deposition (CVD). Accordingly, a first silicon-carbon composite, in which amorphous silicon was dispersed within the porous carbon matrix, was prepared.

### Preparation Example 2: Preparation of Second Silicon-Carbon Composite

Crystalline silicon particles having an average particle diameter of about 80 nm to 120 nm were prepared by ball milling micro-sized silicon particles (average particle diameter of 1 μm to 5 μm). The crystalline silicon particles, stearic acid and ethanol were mixed in a weight ratio of 9:1:10 to prepare a dispersion. Using a spray dryer, the dispersion was spray dried at a temperature of 120° C.

The spray dried product and mesocarbon pitch were mixed at a weight ratio of 50:20 and heat-treated at a temperature of 900° C. to 1000° C. under a N₂ atmosphere to form a coating layer containing amorphous hard carbon. Thereby, a second silicon-carbon composite including crystalline silicon particles and amorphous hard carbon was prepared.

### Preparation Example 3: Preparation of Negative Electrode Plate

A first active material slurry was prepared by mixing 10 parts by weight of the first silicon-carbon composite according to Preparation Example 1, 86 parts by weight of first graphite, 1 part by weight of carboxymethyl cellulose and 1 part by weight of styrene butadiene rubber in a water solvent. A second active material slurry was prepared by mixing 10 parts by weight of the second silicon-carbon composite according to Preparation Example 2, 86 parts by weight of second graphite, 1 part by weight of carboxymethyl cellulose and 1 part by weight of styrene butadiene rubber in a water solvent.

The first active material slurry was coated, dried, and rolled on a Cu foil current collector to form a first negative electrode active material layer. The second active material slurry was coated, dried, and rolled on the first negative electrode active material layer to form a second negative electrode active material layer. Thus, a negative electrode according to Embodiment 1 was prepared.

### Comparative Example 1

The second active material slurry according to Preparation Example 2 described above was first coated, dried, and rolled on the Cu foil current collector to form the second active material layer. The first active material slurry according to Preparation Example 1 described above was coated, dried, and rolled on the second active material layer to form a first active material layer. Thus, a negative electrode according to Comparative Example 1 was prepared.

In other words, in Comparative Example 1, a negative electrode plate for a rechargeable lithium battery was manufactured by reversing the stacking order of the first active material layer and the second active material layer from the stacking order in Embodiment 1.

### Comparative Example 2

A negative electrode plate for a rechargeable lithium battery was manufactured by forming only the second active material layer on the Cu foil current collector while omitting the formation of the first active material layer.

### Comparative Example 3

A negative electrode plate for a rechargeable lithium battery was manufactured by forming only the first active material layer on the Cu foil current collector while omitting the formation of the second active material layer.

### Evaluation Example 1: SEM Image Analysis of Negative Electrode Active Material

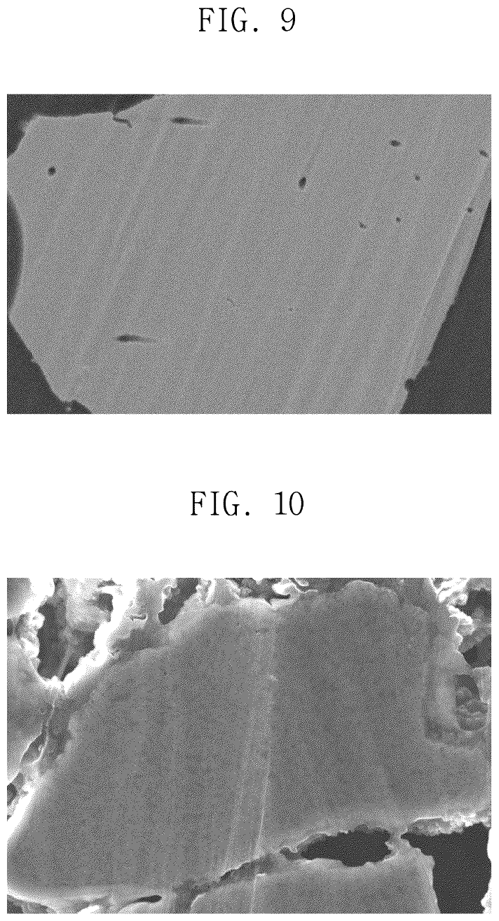

SEM image analysis was performed to analyze the size, shape, and distribution of the silicon particles of each of the first silicon-carbon composite and the second silicon-carbon composite prepared according to Embodiment 1. After cutting the coating form of the first silicon-carbon composite and the second silicon-carbon composite to 10 nm×10 nm or less according to the chamber size, gold (Au), palladium (Pd), or carbon (C) was coated, and the image was analyzed at a distance of 5 nm to 10 nm. SEM images of the first and second silicon-carbon composites prepared according to Embodiment 1 were converted to grayscale and shown in FIG. 9 and FIG. 10, respectively. In these images, dark regions correspond to silicon, and bright regions correspond to carbon. An automatic threshold value was set by the Otsu algorithm using Image J, and then the arithmetic mean of the long axis and the short axis of the silicon particles was calculated. The average particle diameter may be determined by measuring an average size of 100 or more particles in an SEM or TEM images.

Referring to FIG. 9, it can be seen that the average particle diameter of the first silicon particles of the first silicon-carbon composite according to Embodiment 1 is about 8 nm. Referring to FIG. 10, it can be seen that the average particle diameter of the second silicon particles of the second silicon-carbon composite according to Embodiment 1 is about 80 nm.

As a result of SEM image analysis, it was confirmed that the first silicon particles had a sphere-shape in which a ratio of a long axis to a short axis was about 1.0. It was confirmed that the second silicon particles had a flake-shape in which a ratio of a long axis to a short axis was about 5.0. It was confirmed that an average particle diameter of the second silicon particles was significantly larger than that of the first silicon particles by about 10 times.

### Evaluation Example 2: Evaluation of Cycle-Life Characteristics

Rechargeable lithium batteries were manufactured in order to evaluate cycle-life characteristics of rechargeable lithium batteries including negative electrodes prepared according to Embodiment and Comparative Examples. A positive electrode active material layer slurry was prepared by mixing 96 wt % of LiNi_{0.8}Co_{0.1}Mn_{0.1}O₂ positive electrode active material, 2 wt % of Ketjen black, and 2 wt % of polyvinylidene fluoride in a N-methyl pyrrolidone solvent.

The positive electrode active material layer slurry was coated on an Al foil current collector, dried, and rolled to manufacture a positive electrode.

Rechargeable lithium batteries (full cells) were manufactured by a conventional method using the negative electrode, the positive electrode, and the electrolyte according to Embodiment 1 and Comparative Examples 1 to 3. As the electrolyte, a mixed solvent of ethylene carbonate and dimethyl carbonate in which 1 M LiPF₆ was dissolved (3:7 volume ratio) was used.

The rechargeable lithium batteries were charged and discharged 1000 times at 1 C, a capacity ratio in each cycle to the discharge capacity in first cycle was calculated. The number of cycles at which the capacity ratio, i.e., the capacity retention rate degraded sharply to less than 80% is shown in Table 1 below as a cycle-life degradation point.

TABLE 1

| | Cycle-life |
|---|---|
| | degradation |
| | point (Cycle) |
| Embodiment 1 | 900 |
| Comparative Example 1 | 800 |
| Comparative Example 2 | 600 |
| Comparative Example 3 | 1000 |

Referring to Table 1, in the case of Comparative Example 1, where the stacking order of the first negative electrode active material layer and the second negative electrode active material layer is reversed, cycle-life characteristics is degraded. In addition, in the case of Comparative Example 2 including only the second negative electrode active material layer, cycle-life characteristics are significantly degraded. In the case of Comparative Example 3, which include only the first negative electrode active material layer, Comparative Example 3 exhibits desired or improved cycle-life characteristics compared to Embodiment 1. However, while Comparative Example 1 and Comparative Example 2 show significantly degraded cycle-life characteristics compared to Comparative Example 3, Embodiment 1 does not exhibit a significant difference in cycle-life characteristics compared to Comparative Example 3.

### Evaluation Example 3: Evaluation of Electrochemical Efficiency

The electrochemical efficiency of the rechargeable lithium batteries including negative electrodes prepared according to Embodiment and Comparative Examples was evaluated. The rechargeable lithium batteries were charged and discharged once at 0.1 C, and a ratio of a discharge capacity to a charge capacity was calculated. The results are shown in Table 2 below.

TABLE 2

| | Efficiency |
|---|---|
| | (%) |
| Embodiment 1 | 92 |
| Comparative Example 1 | 89 |
| Comparative Example 2 | 88 |
| Comparative Example 3 | 90 |

Referring to Table 2, in the case of Comparative Example 1, where the stacking order of the first negative electrode material layer and the second negative electrode active material layer is reversed, efficiency is reduced. In addition, in the case of Comparative Example 2 including only the second negative electrode active material layer, it can be confirmed that efficiency is lower than the efficiency of Embodiment 1.

### Evaluation Example 4: Evaluation of Resistance Properties

Resistance characteristics of the rechargeable lithium batteries according to Embodiment and Comparative Examples were evaluated. Resistance characteristics were evaluated using electrochemical impedance spectroscopy (EIS) with the constant voltage method at SOC 50, where the effect of current variation is the least significant. At this time, the frequency range was 0.1 mHz to 100 kHz, and the current intensity was 0.1 mA. The results are shown in Table 3 below. The internal resistance in Table 3 refers to the sum of all resistances.

TABLE 3

| | Internal |
|---|---|
| | Resistance |
| | (Ω) |
| Embodiment 1 | 5 |
| Comparative Example 1 | 7 |
| Comparative Example 2 | 5 |
| Comparative Example 3 | 8 |

Referring to Table 3, in the case of Comparative Example 1, where the stacking order of the first negative electrode active material layer and the second negative electrode active material layer is reversed, internal resistance is higher than the internal resistance in Example 1. In the case of Comparative Example 2, which includes only the second negative electrode active material layer, has the lowest internal resistance, while Embodiment 1 has a similarly low value. In addition, it can be seen that internal resistance is reduced when the second silicon-carbon composite is further included, as compared with Comparative Example 3 including only the first silicon-carbon composite and Embodiment 1 including both the first silicon-carbon composite and the second silicon-carbon composite.

The negative electrode for the rechargeable lithium battery according to example embodiments of the present disclosure, may include the first negative electrode active material layer having desired or improved cycle-life characteristics, and the second negative electrode active material layer which is located closer to a positive electrode, having desired or improved resistance characteristic. Thus, the negative electrode, and the rechargeable lithium battery including the negative electrode, may have desired or improved cycle-life characteristics and resistance characteristics.

While the present disclosure has been described with reference to example embodiments, it should be understood that these example embodiments are provided for illustrative purposes only and do not limit the scope of the present disclosure. Various modifications and equivalent arrangements may be made without departing from the spirit and scope of the appended claims. Accordingly, the described embodiments should be regarded as examples rather than limitations of the present disclosure.

What is claimed is:

1. A negative electrode for a rechargeable lithium battery, the negative electrode comprising:
a negative electrode current collector and a negative electrode active material layer on the negative electrode current collector,
wherein the negative electrode active material layer comprises a first negative electrode active material layer on the negative electrode current collector and a second negative electrode active material layer on the first negative electrode active material layer,
wherein the first negative electrode active material layer comprises a first silicon-carbon composite and a first graphite,
wherein the first silicon-carbon composite comprises a first carbon and first silicon particles dispersed within the first carbon,
wherein the second negative electrode active material layer comprises a second silicon-carbon composite and a second graphite,
wherein the second silicon-carbon composite comprises a second carbon and second silicon particles dispersed within the second carbon, and
wherein an average particle diameter of the second silicon particles is greater than an average particle diameter of the first silicon particles.

2. The negative electrode as claimed in claim 1, wherein a ratio of the average particle diameter of the second silicon particles to the average particle diameter of the first silicon particles is in a range of about 5 to about 15.

3. The negative electrode as claimed in claim 1, wherein an amount of the first graphite in the first negative electrode active material layer is in a range of about 50 parts by weight to about 90 parts by weight relative to 100 parts by weight of the first negative electrode active material layer.

4. The negative electrode as claimed in claim 1, wherein an amount of the first silicon-carbon composite in the first negative electrode active material layer is in a range of about 10 parts by weight to about 50 parts by weight relative to 100 parts by weight of the first negative electrode active material layer.

5. The negative electrode as claimed in claim 1, wherein an amount of the second graphite in the second negative electrode active material layer is in a range of about 50 parts by weight to about 90 parts by weight relative to 100 parts by weight of the second negative electrode active material layer.

6. The negative electrode as claimed in claim 1, wherein an amount of the second silicon-carbon composite in the second negative electrode active material layer is in a range of about 10 parts by weight to about 50 parts by weight relative to 100 parts by weight of the second negative electrode active material layer.

7. The negative electrode as claimed in claim 1, wherein the average particle diameter of the first silicon particles is in a range of about 1 nm to about 10 nm.

8. The negative electrode as claimed in claim 1, wherein the average particle diameter of the second silicon particles is in a range of about 50 nm to about 120 nm.

9. The negative electrode as claimed in claim 1, wherein the first graphite comprises natural graphite and artificial graphite, and
wherein an amount of the natural graphite in the first negative electrode active material layer is greater than an amount of the artificial graphite in the first negative electrode active material layer.

10. The negative electrode as claimed in claim 1, wherein the second graphite comprises natural graphite and artificial graphite, and
wherein an amount of the artificial graphite in the second negative electrode active material layer is greater than an amount of the natural graphite in the second negative electrode active material layer.

11. The negative electrode as claimed in claim 1, wherein a ratio of a long axis of the first silicon particles to a short axis of the first silicon particles is less than a ratio of a long axis of the second silicon particles to a short axis of the second silicon particles.

12. The negative electrode as claimed in claim 11, wherein the first silicon particles have a sphere-shape in which the ratio of the long axis to the short axis is in a range of about 1.0 to about 1.2.

13. The negative electrode as claimed in claim 11, wherein the second silicon particles have a flake-shape in which the ratio of the long axis to the short axis is in a range of about 2.0 to about 40.

14. The negative electrode as claimed in claim 1, wherein an average particle diameter of at least one of the first silicon-carbon composite and the second silicon-carbon composite is in a range of about 5 μm to about 15 μm.

15. A rechargeable lithium battery, comprising:
the negative electrode as claimed in claim 1;
a positive electrode; and
an electrolyte.

16. A method for manufacturing a negative electrode, the method comprising:
forming a first silicon-carbon composite;
mixing the first silicon-carbon composite and a first graphite to form a first negative electrode active material slurry;
forming a second silicon-carbon composite;
mixing the second silicon-carbon composite and a second graphite to form a second negative electrode active material slurry;
coating the first negative electrode active material slurry on a negative electrode current collector to form a first negative electrode active material layer; and
coating the second negative electrode active material slurry on the first negative electrode active material layer to form a second negative electrode active material layer,
wherein forming the first silicon-carbon composite comprises performing a vapor deposition process to form first silicon particles within a first carbon, and
wherein forming the second silicon-carbon composite comprises performing a milling process to form second silicon particles, and coating the second silicon particles with a second carbon.

17. The method as claimed in claim 16, wherein forming the first silicon-carbon composite further comprises forming the first carbon using a porous carbon matrix.

18. The method as claimed in claim 16, wherein the vapor deposition process is performed at a temperature in a range of about 400° C. to about 700° C.

19. The method as claimed in claim 16, wherein the milling process is performed at a temperature in a range of about 15° C. to about 100° C.

20. The method as claimed in claim 16, wherein an average particle diameter of the second silicon particles is greater than an average particle diameter of the first silicon particles.
